(19) United States
(12) Patent Application Publication
(10) Pub. No.: US 2024/0412888 A1
(43) Pub. Date: Dec. 12, 2024

(54) PHOTONICALLY INTEGRATED ATOMIC TWEEZER CLOCK

(71) Applicant: The Trustees of Columbia University in the City of New York, New York, NY (US)

(72) Inventors: Sebastian Will, New York, NY (US); Alexander Gaeta, New York, NY (US); Nanfang Yu, New York, NY (US); Michal Lipson, New York, NY (US)

(73) Assignee: The Trustees of Columbia University in the City of New York, New York, NY (US)

(21) Appl. No.: 18/393,267

(22) Filed: Dec. 21, 2023

Related U.S. Application Data
(60) Provisional application No. 63/434,586, filed on Dec. 22, 2022.

(51) Int. Cl. G21K 1/00; G04F 5/14

(52) U.S. Cl. CPC G21K 1/006; G04F 5/14

(57) ABSTRACT

The disclosed subject matter relates to a photonically integrated atomic tweezer clock. An example atomic tweezer clock can include a laser system, a holographic metasurface, a vacuum system, and a cold atoms source, wherein the holographic metasurface generates an optical tweezer array, and the atoms are trapped by the optical tweezer array in the vacuum system for generating an atomic tweezer clock. In certain embodiments, the laser system is integrated with frequency combs in chip-scale to ensure compactness and robustness.

### CROSS-REFERENCE TO RELATED APPLICATION

This application claims priority to U.S. Provisional Patent Application Ser. No. 63/434,586, filed Dec. 22, 2022, which is hereby incorporated by reference in its entirety.

### BACKGROUND

Optical atomic clocks can serve as precise quantum sensors. Certain optical lattice clocks based on specific atoms have obtained timing precision of one part in 10¹⁹. However, such optical lattice clocks can be relatively large, occupy several optical benches, and require complicated and costly operation in highly specialized laboratory settings and sites.

Therefore, there is a need for optical atomic clocks that are compact, robust, and deployable in a variety of settings not limited to a specialized laboratory.

### SUMMARY

The disclosed subject matter provides a compact, robust, and widely deployable atomic clock. According to certain embodiments, the disclosed subject matter provides a photonically integrated atomic tweezer clock. An exemplary atomic tweezer clock includes a laser system configured to generate one or more incident laser beams; a holographic metasurface configured to generate an optical tweezer array from one or more incident laser beams; a vacuum chamber configured to receive a projection of the optical tweezer array generated by the holographic metasurface; and a cold atoms source configured to generate a cloud of atoms in the vacuum chamber. The optical tweezer array is further configured to capture one or more atoms from the plurality of atoms in the vacuum chamber.

In certain embodiments, the clock further includes a measurement system configured to collect and measure atom flux for trapped atoms.

In certain embodiments, the plurality of atoms includes ⁸⁷Sr atoms.

In certain embodiments, the optical tweezer array uses lasers with a wavelength of 813 nanometers.

In certain embodiments, the optical tweezer array uses lasers with a wavelength of 497 nanometers.

In certain embodiments, the optical tweezer array is two-dimensional.

In certain embodiments, the vacuum chamber includes a two-stage magneto-optical trap (“MOT”). In certain embodiments, a first stage of the MOT includes a blue 2D MOT having a wavelength of 461 nanometers. In certain embodiments, a second stage of the MOT includes a narrow-line MOT having a wavelength of 689 nanometers.

In certain embodiments, the plurality of atoms is trapped in the vacuum chamber as an atomic array.

In certain embodiments, the holographic metasurface is positioned outside the vacuum chamber.

In certain embodiments, the cold atoms source includes a dispenser configured to release the plurality of atoms into the vacuum chamber.

In certain embodiments, the clock further includes a measurement system configured to collect and measure atom flux of the trapped plurality of atoms.

In certain embodiments, the laser system is chip-scale integrated with frequency combs.

In certain embodiments, the laser system is integrated with a SiN chip.

In certain embodiments, the frequency combs are configured to have spectral overlap with a line of the plurality of atom.

In certain embodiments, the optical tweezer array includes a plurality of traps for atoms at multiple wavelengths.

In certain embodiments, the atomic array is adapted to manipulate the vibrations and transitions of trapped atoms for a readout of the photonically integrated atomic tweezer clock.

Further, the disclosed subject matter provides methods for constructing a photonically integrated atomic tweezer clock. An exemplary method includes inducing one or more incident laser beams, generating an optical tweezer array from the incident laser beam via a holographic metasurface, projecting the optical tweezer array into a vacuum chamber, and trapping atoms generated by a cold atoms source in the vacuum chamber, wherein the atoms are trapped by the optical tweezer array in a vacuum chamber.

In certain embodiments, the laser beams are generated by a chip-scale laser system.

In certain embodiments, the chip-scale laser system is integrated with frequency combs.

In certain embodiments, the laser beams are integrated and manipulated on the holographic metasurface to enhance robustness.

In certain embodiments, the atoms are released by at least heating a filling of loaded bulk atom source from a dispenser in the cold atoms source.

In certain embodiments, the method further includes measuring atom flux of the trapped atoms by pushing the trapped atoms into a glass cell.

In certain embodiments, the method further includes manipulating vibrations and transitions of the trapped atoms within the atomic array.

In certain embodiments, the method further including outputting a readout of the atomic tweezer clock.

### BRIEF DESCRIPTION OF THE DRAWINGS

FIG. 1 shows a schematic diagram of a photonically integrated atomic tweezer clock, according to embodiments of the disclosed subject matter.

FIG. 2A shows an exemplary chip-scale laser system, according to embodiments of the disclosed subject matter.

FIG. 2B shows tuning performance of a laser near 660 nm generated from the chip-scale laser system shown in FIG. 2A.

FIG. 2C shows an illustration of a high-power integrated laser constructed with optical images of the multimode gain and silicon nitride chip, according to embodiments of the disclosed subject matter.

FIG. 3A shows an image of an exemplary fabricated metasurface hologram for generating optical tweezer traps, according to embodiments of the disclosed subject matter.

FIG. 3B shows scanning electron micrographs of nano-scale metasurface hologram shown in FIG. 3A, according to embodiments of the disclosed subject matter.

FIG. 3C shows scanning electron micrographs (partial) of nano-scale metasurface hologram shown in FIG. 3B, according to embodiments of the disclosed subject matter.

FIG. 3D shows a schematic image of a square lattice at wavelength of 520 nm generated by exemplary holographic metasurface according to embodiments of the disclosed subject matter.

FIG. 3E shows a schematic image of a Kagome lattice at a wavelength of 520 nm generated by exemplary holographic metasurface according to embodiments of the disclosed subject matter.

FIG. 4A shows a schematic image for a cold atoms source according to embodiments of the disclosed subject matter.

FIG. 4B shows a schematic image for an exemplary transition of laser cooling of atoms and clock operation on the ultranarrow clock transition according to embodiments of the disclosed subject matter.

FIG. 4C shows a schematic fluorescence image for trapping atoms with high resolution generated by an exemplary optical tweezer array according to embodiments of the disclosed subject matter.

FIG. 5 shows a method of timekeeping using a photonically integrated atomic tweezer clock according to embodiments of the disclosed subject matter.

It is to be understood that both the foregoing and the following detailed description are exemplary and are intended to provide further explanation of the disclosed subject matter.

### DETAILED DESCRIPTION

The disclosed subject matter provides devices and techniques for quantum sensing. Reference will now be made in detail to the various exemplary embodiments of the disclosed subject matter, which are illustrated in the accompanying drawings. The structure and corresponding method of operation of the disclosed subject matter will be described in conjunction with the detailed description of the system. The accompanying drawings, where like reference numerals refer to identical or functionally similar elements throughout the separate views, serve to further illustrate various embodiments and to explain various principles and advantages all in accordance with the disclosed subject matter.

### Definitions

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, up to 10%, up to 5%, and up to 1% of a given value. Alternatively, e.g., with respect to biological systems or processes, the term can mean within an order of magnitude, within 5-fold, and within 2-fold, of a value.

As used herein, the term “atomic clock” refers to highly accurate timekeeping device that relies on the vibrations or transitions of atoms or molecules to measure time. These clocks are among the most precise timekeeping instruments available and are widely used in scientific research, tele-communications, global positioning systems (GPS), and various other applications where accurate timekeeping is critical. An “optical” atomic clock refers to a highly accurate timekeeping device that uses optical frequencies (light) to measure time, via measuring the frequency of optical transitions in atoms or ions. A “tweezer clock” is a type of optical atomic clock.

As used herein, the term “clock interrogation” refers to the process of interrogating an atomic clock to determine its current time, frequency, or other relevant parameters with high precision. To ensure accuracy, atomic clocks are often subject to interrogation or measurement processes that involve sending electromagnetic signals or laser light to the atoms within the clock and observing their responses. Interrogation is important to maintaining and verifying the performance of atomic clocks, as well as for synchronization in various applications, such as global navigation systems (e.g., GPS), telecommunications, scientific research, and more.

As used herein, the terms “collisional shifts” and “atom tunneling” refer to two factors that interfere with the precision and accuracy of timekeeping in atomic clocks. Collisional shifts refer to collisions between atoms which can perturb the energy levels of the atoms, leading to frequency shifts. Likewise, atom tunneling occurs when atoms overcome energy barriers and move through them, impacting the atomic clock's operation. “Full suppression” refers to the process of minimizing or eliminating frequency shifts due to collisional shifts and atomic tunneling. Examples of full suppression techniques include “laser cooling” and “trapping.”

As used herein, the term “MOT” or “magneto optical traps” refers to a system capable of capturing or trapping atoms, for example by using laser cooling. The MOT system or apparatus can be generally integrated with a spatially-varying magnetic field and laser system, the combination of which allows the atoms to be captured and maintained because the atoms are moving slowly enough at low temperature created by laser cooling to be trapped using the spatially-varying magnetic fields.

As used herein, the term “atomic flux” is a term generally used in the field of quantum physics to refers to the rate at which atoms move through a given area, including a hole or opening, per unit time. Atomic flux can be measured using a spectrometry. Atomic flux can be quantified using the amount of atoms that flow through a unit area in a unit time, for example, but not limited to, atoms per second.

As used herein, the term “frequency combs” refers to precise and stable sources of laser light with evenly spaced, discrete spectral lines. Frequency combs are used in various scientific and technological applications, including spectroscopy, timekeeping, and atomic physics. Further, the term “octave-spanning comb” refers to a type of optical spectrum that spans a frequency range equivalent to an octave. In the context of optical frequency combs, octave-spanning comb typically covers a broad range of optical frequencies, generally with evenly spaced spectral lines.

As used herein, the term “Zeeman slower” refers to a device used in atomic physics to cool and slow down an atomic beam by using the Zeeman effect, capable of being used in the fields of atomic clocks, and quantum computing.

As used herein, the term “magic wavelength” refers to a specific wavelength of light that has the unique property of exerting the same force on an atom in different energy states.

### Photonically Integrated Atomic Tweezer Clock

According to embodiments, the disclosed subject matter provides a photonically integrated atomic tweezer clock. An exemplary atomic tweezer clock can be based on ⁸⁷Sr atoms trapped in an optical tweezer array, which can be projected into an integrated chamber, e.g., a vacuum chamber. In non-limiting embodiments, the disclosed device can be based on the ultranarrow clock transition in ⁸⁷Sr (e.g., ¹S₀↔³P₀). The optical tweezer array can enhance clock precision and robust construction integration.

In certain embodiments, the atomic tweezer clock can be configured to trap individual atoms in an optical tweezer array. According to embodiments, the optical tweezer array can achieve up to 1,000 tweezer traps. The number of traps used can enhance robustness of the system against vibration and acceleration, and enhance suppression of motional heating and atom loss. Trapping of specific atoms, e.g., ⁸⁷Sr, in an optical tweezer array can provide advantages over general optical lattice trapping, allowing for enhanced clock precision and robust system integration.

In certain embodiments, the disclosed clock can be configured to enhance a duty cycle compared to traditional lattice clocks. For example, the trapped atoms can be interrogated non-destructively multiple times, which keeps the atomic sample intact for repeated clock interrogations, thereby reducing deadtime from atomic sample preparation. That, in turn, reduces Dick noise and improves clock precision.

In certain embodiments, the disclosed clock can be configured for full suppression of collisional shifts and tunneling-induced dephasing between trapping sites, leading to higher clock precision.

In certain embodiments, the disclosed clock can be configured to use metasurface holograms for the generation of “magic” optical tweezer arrays for ⁸⁷Sr and beam shaping of laser cooling beams.

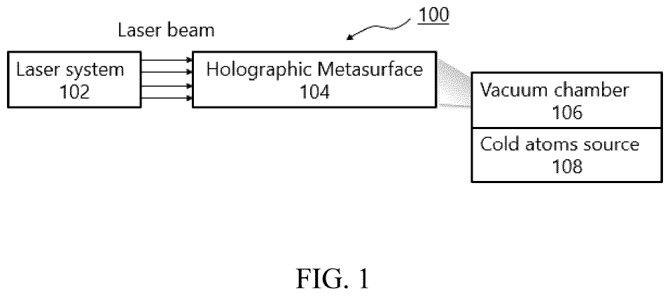

As shown in FIG. 1, an exemplary photonically integrated atomic tweezer clock 100 can include a laser system 102, a holographic metasurface 104, a vacuum chamber 106, and a cold atoms source 106. Examples of each of these components are described in further detail below.

Laser System (Chip-Scale Integrated with High Frequency Comb)

According to embodiments, laser system 102 can include a plurality of laser sources configured to emit a series of incident laser beams across several wavelengths in the visible range and wide range. Certain atomic clock setups substantially rely on free-space optics that occupy dozens of square feet of area of an optical table space, which makes the systems prone to environmental influences, e.g., temperature fluctuations, vibrations, etc.

According to embodiments of the disclosed subject matter, laser systems can include chip-based integrated laser sources and frequency combs. For example, both the laser source and frequency comb can be integrated with a silicon chip. A chip-scale laser system integrated with frequency combs can be configured to control the linewidth of the emitted light to be significantly narrowed in operation.

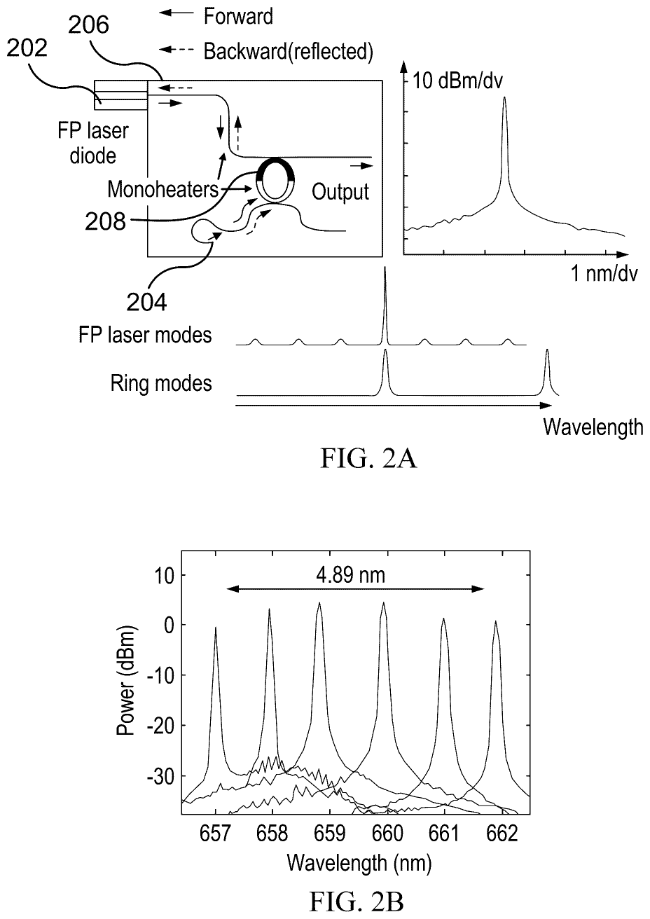

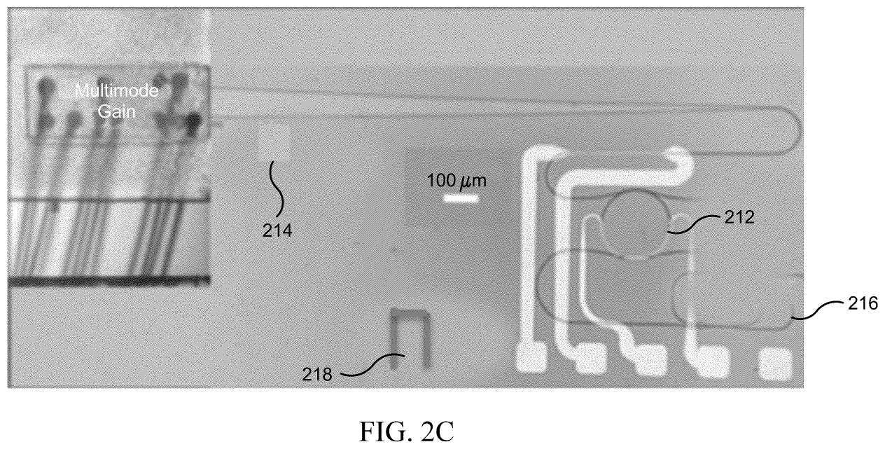

Laser system 102 can include integrated chip-scale laser systems and optical parametric oscillators for all required wavelengths and linewidths. According to embodiments, FIG. 2A illustrates an exemplary schematic of a chip-scale laser for the integrated atomic clocks of the disclosed subject matter. Specifically, as can be seen, the disclosed subject matter can include a integrated laser system. In certain embodiments, integrated laser system can include a semiconductor laser diode 202 using Fabry-Perot interferometer, e.g., Fabry-Perot laser diode, with the desired center wavelengths. The laser diode can be edge-coupled to a photonic chip 206. The photonic chip 206 can have a surface area of about 1-10 square centimeter (cm²), which can substitute a conventional free-space laser system occupying an area up to 1-3 square feet in contrast. According to embodiments, the chip 206 can include ultralow-loss optical feedback loops 204 based, for example, on a ring resonator 208, which can cause self-injection of the laser diodes. The linewidth of the light emitted by laser diodes can be narrowed by a factor proportional to the inverse-squared of the quality factor of the ring resonator 208. In certain embodiments, the linewidth can be narrowed to as low as around 10 Hz, as illustrated in FIG. 2B indicating the tuning performance of such a chip-scale laser system in FIG. 2A.

In certain embodiments, as illustrated in FIG. 2C, the disclosed atomic clock can include a high-power integrated laser designed and configured to facilitate multiple optical modes or resonance within the laser cavity. The integrated laser can be compact and integrated with a SiN chip. As depicted in FIG. 2C, the SiN chip can include a number of components, including, for example not limitation, a high-Q ring 212, horn taper 214, and reflector 216. These elements are intricately integrated to play a crucial role in narrowing the linewidth (i.e., width of the frequency spectrum emitted from the laser) of the lasers, thereby optimizing the overall performance of the atomic clock. In certain embodiments, several heaters 218 can be mounted on the SiN chip to provide precise temperature control and stability. This configuration can enhance the functionality and reliability of the atomic clock, ensuring accurate and efficient operation through enabling fast feedback control on the lasers and allowing to stabilize lasers frequency with high precision to a reference system. High-power laser is beneficial, if not required, for cooling and trapping. According to embodiment, a multimode Fabry-Perot lasers can be coupled to a silicon nitride (SiN) chip and designed to force the lasers to operate in a single longitudinal and transverse mode. SiN is a material that is used as an integral component of the laser system setup. This coupling can involve aligning the lasers and an optical waveguide of the chip for efficient light transfer.

In addition to achieve the desired narrow linewidth (e.g., lower than 1 Hz) for the clock laser at a specific wavelength (e.g., 698 nm), an integrated optical parametric oscillator based on four-wave mixing in micro-resonators can be used. Such integrated laser sources can be beneficial as they can achieve Schawlow-Townes linewidths below 1 Hz.

According to embodiments, an octave-spanning optical frequency comb integrated with the SiN-coupled laser source can be used in the disclosed atomic clocks. There are two approaches for generating octave-spanning combs: Kerr comb generation (KCG) and supercontinuum generation. Production of a stabilized comb using KCG can be challenging because of the difficulty of producing an octave-spanning comb with high conversion efficiency with comb spacings that are sufficiently small to be electronically detectable. However, these challenges can be addressed by use of SiN microresonators including operating outside of the conventional soliton regime yet still operating with a mode-locked comb such that the conversion efficiency and the comb-line powers at the edges of the spectrum is high and leads to a comb spectrum with a uniform intensity distribution. Accordingly, a comb having significant spectral overlap with substantially most of the trapped atom's lines and that is configured to facilitate cooling, trapping, and interrogation lasers to lock to the comb can be used.

### Holographic Metasurface

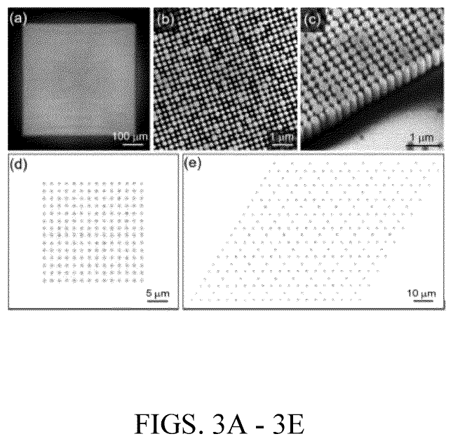

According to embodiments, the photonically integrated atomic tweezer clock of the disclosed subject matter can include an optical tweezer array. The optical tweezer array is movable to an appropriate chamber for trapping atoms. In certain embodiments, the optical tweezer array can be generated by a holographic metasurface 104, then projected into a sealed chamber. The tweezer array can be a two-dimensional tweezer array. For example, the holographic metasurface 104 can be configured to have a passive optical element that has high structural integrity and does not consume power. Such an arrangement can be beneficial because it is more compact and robust than the use of free-space optics, acousto-optical deflectors, or spatial light modulators that are typically used for the creation of tweezer arrays. FIG. 3A-3E illustrates a schematic of an exemplary holographic metasurface 104 securing a high-power handling capability, for an optical tweezer traps generation according to disclosed subject matter. According to non-limiting embodiments, FIG. 3A shows an exemplary image of a metasurface hologram for generating optical tweezer traps. FIG. 3B and FIG. 3C (partial image in detail) show scanning electron micrographs of exemplary nano-scale metasurface holograms according to embodiments of the disclosed subject matter. FIG. 3D shows a 2D square lattice (FIG. 3d) and FIG. 3E shows a Kagome lattice, each at a wavelength of 520 nm and generated by the exemplary metasurface hologram according to embodiments of the disclosed subject matter.

In certain embodiments, metasurface holograph 104 can be rigidly integrated into the incident projected laser beam path generated by laser system 102, thereby ensuring a high degree of robustness. For example, regarding rigid integration, the metasurface can be placed in a common mounting structure as the projection optics that projects the tweezer array onto the atoms, ensuring an effective common-mode rejection of vibrational noise. In certain embodiments, the holographic metasurface 104 can be configured for the magic trapping wavelengths of ⁸⁷Sr. Magic wavelengths of ⁸⁷Sr include 813 nm and 497 nm. At wavelength of 813 nm, the AC Stark shifts of ¹S₀ and ³P₀ are identical. Additionally, wavelength of 497 nm has five times higher polarizability compared to the polarizability of a magic transition at 813 nm, which allows for creation of optical tweezer traps with only 2 mW of power per trap. Non-limiting exemplary embodiments of metasurface holograph 104 can be composed of a 2D tweezer array of subwavelength pixels having complex cross-sectional shapes (such as those illustrated in FIGS. 3A-3C) for control of the phase and amplitude of the optical near-field with subwavelength resolution.

In certain embodiments, the holographic metasurface 104 can be located outside of vacuum chamber 106, and tweezer trap will be projected into the vacuum system 106 using a high-resolution objective, for example, a G Plan Apo 50X objective. Such optical tweezer traps generated by the holographic metasurface can have high positioning accuracy and excellent size and intensity uniformity.

In certain embodiments, samples can be prepared in rapidness, ranging from 100 milliseconds to 1 second, for instance.

### Vacuum Chamber

In certain embodiments, the vacuum system 106 can be constructed from commercially available ultra-high vacuum (UHV) glass cell. The vacuum environment can be operated and maintained by an ion pump with a specific pumping speed, e.g., 20 liters per second (L/s). The incident cooling laser and trapping laser beams released by laser system 102 traverses into holographic metasurface 104 and arrives at vacuum chamber 106, where the atoms are trapped.

In certain embodiments, the optical tweezer array generated above can be projected into vacuum chamber 106 for further cooling and trapping the atoms, consequently constructing an atomic clock.

### Cold Atoms Source

According to embodiments, the disclosed atomic tweezer clock can include a cold atoms source for generating cold atomic samples, e.g., a cloud of a plurality of Sr atoms. According to embodiments, an exemplary cold atoms source 108 can be configured to generate a cold atomic beam of ⁸⁷Sr atoms with a high flux, e.g., more than 10⁷ atoms per second. In certain embodiments, cold atoms source 108 is configured to offset the 10-times smaller natural abundance of ⁸⁷Sr as compared to ⁸⁸Sr to generate a high flux of 10⁷ atoms per second.

In certain embodiments as shown in FIG. 1, an exemplary cold atoms source 108 can be integrated into vacuum chamber 106 in order to trap atoms within vacuum chamber 106, thereby allowing an atomic array to be generated in vacuum chamber 106. Alternatively, a separate cold atoms source 108 can be connected with the vacuum chamber downstream for dispensing atoms into vacuum chamber 106.

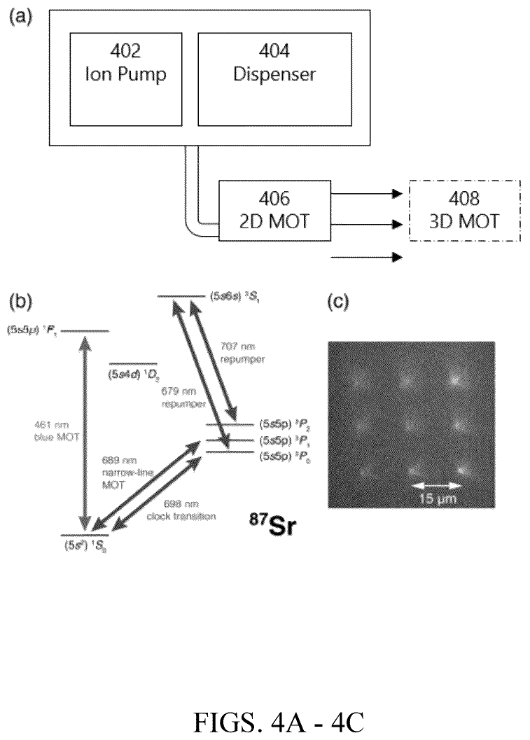

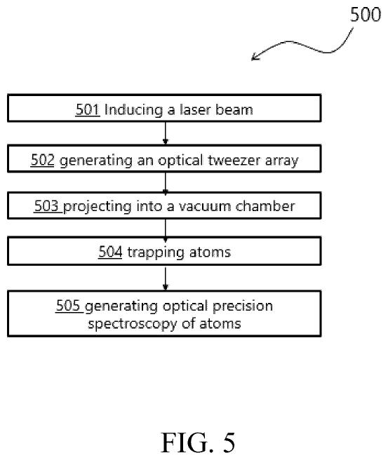

As shown in FIG. 4A, according to exemplary embodiments, cold atoms source 108 can include an ion pump 402, a dispenser 404, a 2D MOT 404, and a 3D MOT 404. An atom source can be loaded from the dispenser 404. Dispenser 404 can be heated to generate a hot atomic jet. In certain embodiments, dispenser 404 is configured via two U-shaped dispensers produced by a commercial vendor (Alfa Vakuo), included of a steel tube, filled with bulk materials, e.g., Sr, with natural abundance. In certain embodiments, a framework with the two dispensers with 2 mm diameter has a filling of 40 mg of Sr. In certain embodiments, the larger capacity dispenser(s) with a filling of more than 200 mg of Sr can be accommodated with a similar design. According to embodiments, the distance between the output opening of dispenser 404 and trapping region of 2D MOT 406 is about 0.5-1.5 cm. Ion pump 402 (not shown) can be built in the cold atoms source for accelerating atoms and maintaining the vacuum.

In order to block the excessive hot atom jet from coating the viewports of the vacuum chamber 106, a shaped shield can be placed around the dispensers. The shaped shield can be shaped specifically, for instance L shaped. The shield can include a cut-out portion that restricts the solid angle of the fanned-out hot atom flux, and the cut-out is narrow enough to protect the viewports from Sr coating and large enough to fully expose the trapping region.

In certain embodiments, cold atoms source 108 can include a two-stage cooling scheme. According to embodiments, as shown in FIG. 4A, two-stage cold atoms source 108 can include a specific wavelength (e.g., blue at 461 nm) 3D MOT 408 and a narrow-line 2D MOT 406 (e.g., at 689 nm).

According to embodiments, a two-stage cooling procedure combining 2D MOT and 3D MOT as described above can generate and maintain ultra-low temperatures at around 1 μK regime, which enable efficient and direct capture of ⁸⁷Sr atoms in the optical tweezer array. For example, FIG. 3C shows a high-resolution fluorescence image of trapped Sr atoms in an optical tweezer. In certain embodiments, atomic clock spectroscopy can be performed by illuminating the atomic tweezer array with a compact laser. According to embodiments, compact laser can have a wavelength of 698 nm, resonant with the ¹S₀↔³P₀ transition and stabilized to a chip-based frequency comb. The clock state can also be non-destructively imaged via fluorescence imagining on the 461 nm ¹S₀↔¹P₁ transition.

FIG. 4B illustrates relevant transition for the laser cooling and repumping of Sr atoms to demonstrate a specific arrangement of MOT in the vacuum chamber 106. For example, for the operation of a 2D MOT, a laser beam with a wavelength at 461 nm is used, and for the operation of 3D MOT, repumping laser beam at wavelengths of 679 nm and 707 nm are used. Selectively, a master laser can be stabilized to a Sr spectroscopy cell and provide laser light for two injection-locked lasers, subsequently providing the optical power at 461 nm for the two MOT, respectively. These specific wavelengths, for example, at 461 nm or 689 nm, can enhance the sustainability and reliability of the optical tweezer traps.

In certain embodiments, the disclosed matter provides a method for constructing a photonically integrated atomic clock.

Benefits of the disclosed subject matter include single atom trapping to maximally benefit from highly coherent internal states and intrinsically suppress systematic shifts, a compact laser system with chip-scale and frequency combs that reduce the complexity and fragility of usual free-space laser system, and a robust optical assembly system to generate tweezer traps and efficiently read out the atomic quantum states.

### Method of Assembling a Photonically Integrated Atomic Clock

The disclosed subject matter provides methods for assembling a robust and deployable photonically integrated atomic clock. In exemplary embodiment, as shown in FIG. 5, method 500 can include, but is not limited to, inducing one or more incident laser beams (501), generating an optical tweezer array from the incident laser beam via a holographic metasurface (502), projecting the optical tweezer array into a vacuum chamber (503), trapping atoms using the optical tweezer array in the vacuum chamber (504), and generating an optical precision spectroscopy of the trapped atoms (505).

Referring to 501, one or more laser beams are induced using laser system 102. For example, laser system 102 can include an integrated chip including one or more laser sources and a frequency comb configured to regulate the projected laser beam, as described above. According to embodiments, and as described above, the chip-based integrated laser source can be configured to be compact and robust. An objective of the atomic clock is to build an ultra-cooling temperature for facilitating a trapping for atoms.

At 502, the generated one or more laser beams are projected into a holographic metasurface 102 for generating an atomic tweezer array that can be used to trap and manipulate atoms in vacuum chamber 106. As discussed above, the laser beam generated by laser system 102 is guided to traverse the holographic metasurface 104 before entering vacuum chamber 106 for trapping atoms. As discussed above, holographic metasurface 104 can adjust or interact with the incident laser beam, ensuring a high degree of robustness. According to embodiments, a tweezer array can be generated by the holographic metasurface 104, which acts as a passive optical element that secures a high structural integrity and high positioning accuracy as well as consume minimal power. An optical tweezer array with at least 100 sites, typically 1000 sites, as described above, for enhanced robustness can be effective against interference factors, such as vibration and acceleration, motional heating and atom loss. Additionally, holographic metasurface 104 can be configured to fully suppress collisional shifts and atom tunneling across the atomic sample. In certain embodiments, as described above, holographic metasurface 104 can be designed for specific trapping wavelengths, e.g., at 813 nm or 497 nm. In an embodiment, the tweezer array for the atomic clock system can be configured to trap atoms at multiple wavelengths with more than 1,000 wavelength tweezer traps.

At 503, following the generation and modification by holographic metasurface 104, the optical tweezer array is projected into vacuum chamber 106 for trapping atoms (S504).

At 504, a laser cooled cloud of atoms generated from cold atoms source 108 can be transferred into a vacuum chamber. Cold atoms source 108 can include a two-stage cooling scheme, as described above. atoms are trapped in each of the plurality of tweezer traps, which are generated by holographic metasurface 104 and projected into a vacuum chamber 106. In vacuum chamber 106, the trapped atoms can be selected from either individual atoms or multiple atoms. In certain embodiments, the specific atoms can be collected as an atomic array that can be used for a timekeeping atomic clock, where these atoms are interrogated by the clock laser beam. In certain embodiments, the atoms are initially pushed into vacuum chamber 106 via a dispenser of the cold atoms source 108, wherein the temperature of the dispenser is maintained between 100-700° C. to release the atoms by heat. An ultracold atomic flux of more than 10⁷ atoms per second can be trapped and collected in vacuum chamber 106 without a bulky Zeeman slower.

At 505, the atoms trapped in the atomic array are interrogated with a laser beam at 698 nm, thereby generating a optical precision spectroscopy of the trapped atoms. This laser is stabilized to the wavelength of the ultranarrow clock transition in ⁸⁷Sr (¹S₀↔³P₀). The optical frequency of this laser is then divided down to the microwave domain via the chip-based frequency comb, as described above. The microwave frequency of the frequency comb serves as frequency standard for precision time-keeping.

For a measurement of the atom flux of trapped atoms, a container, e.g., a vacuum glass cell, can be used for collecting the atoms in the cold atoms source 108, wherein the trapped atoms are pushed by a push laser beam into the glass cell. The generated atomic array is a fundamental component of a photonically integrated atomic tweezer clock of the disclosed subject matter. In certain embodiments, the trapped atoms can be Sr, e.g., ⁸⁷Sr. Alternatively, the trapped atoms can be multiple atoms, e.g., Sr, Yb, Cs, or Rb atoms.

In certain embodiments, subsequent to the above procedure, a readout of the photonically integrated atomic tweezer clock of the disclosed subject matter can prepared. Specifically, a readout of the atomic quantum states of the trapped atoms can be output. The atomic tweezer clock can use the vibrations or transitions of trapped atoms within the atomic array generated at S503 to define a unit of time. A non-destructive readout for the atomic tweezer clock can be displayed by keeping the atomic sample intact for repeated clock interrogation, subsequently reducing deadtime from atomic sample preparation.

In the above process of assembling the atomic tweezer clock, generating the atomic tweezer traps via the holographic metasurface achieves full suppression of collisional shifts and atom tunneling between the trapping sites. In addition, a non-destructive readout can be performed to keep the atomic sample intact for a repeated clock interrogation, reducing deadtime from atomic sample preparation, and thus the Dick effect, to a minimum. Moreover, a frequency stability of at least 5×10⁻¹⁶ τ⁻¹² can be achieved while significantly reducing systematic effects compared to tweezer arrays for other types of atoms.

### Utilization of Photonically Integrated Atomic Tweezer Clock

The photonically integrated atomic tweezer clock provided by the disclosed subject matter can be utilized in the fields of various quantum operations, including but not limited to optical clock, quantum simulator, quantum computer, and GPS system, etc.

The photonically integrated atomic clock of the disclosed subject matter can be widely applied to quantum sensing applications. For example, the development of compact, robust, and precise lasers, frequency combs, and techniques for beam shaping of light fields will be widely applicable to many quantum sensing schemes, including networks of entangled quantum sensors, which rely on lasers. Deployment of precision timing is also necessary for future networks of entangled quantum sensors.

The photonically integrated atomic clock of the disclosed subject matter can allow implementation of schemes for quantum-enhanced timekeeping. To that end, entanglement between the trapped Sr atoms can be generated. For example, generation of entanglement can be based on Rydberg-Rydberg interactions. In certain embodiments, the atomic tweezer clock-based approach which enables the individual addressing of single atoms (e.g., Sr atom), can also address couple atoms with entangled photons. This can be aided by integrated optical cavities to directly interface with fiber optics. In further applications, the networks of entangle clocks can serve as an detector for gravitational waves and investigations at the interface of quantum and gravitational physics. The entanglement between atomic tweezer arrays can be functioned as a groundwork for a distributed quantum computing of atomic quantum processors.

Beyond the implication in physical fields, the photonically integrated atomic clock of the disclosed subject matter further can be deployed as master clock network to provide navigation capabilities in GPS denied areas, can enable relativistic geodesy that allow locating natural resources, and can enable precision synchronization in the electrical power grid, which is increasingly important with the increasing number of delocalized renewable energy sources. In space, such an atomic clock can serve as a backbone of a GPS system with improved accuracy, improving precision from meter to millimeter-accuracy. Such an improvement is critical for advanced logistics approaches, ranging from self-driving vehicles to routing of drones.

The disclosed subject matter is not to be limited in scope by the specific embodiments described herein. Indeed, various modifications of the disclosure in addition to those described herein will become apparent to those skilled in the art from the foregoing description and the accompanying figures. Such modifications are intended to fall within the scope of the appended claims.

What we claim is:

1. A photonically integrated atomic tweezer clock, comprising:
a laser system configured to generate one or more incident laser beams;
a holographic metasurface configured to generate an optical tweezer array from the one or more incident laser beam;
a vacuum chamber, configured to receive a projection of the optical tweezer array generated by the holographic metasurface; and
a cold atoms source configured to generate a cloud of a plurality of atoms in the vacuum chamber, wherein the optical tweezer array is configured to capture one or more atoms from the plurality of atoms in the vacuum chamber.

2. The clock of claim 1, wherein the plurality of atoms includes ⁸⁷Sr atoms.

3. The clock of claim 1, wherein the optical tweezer array has a wavelength of 813 nanometers.

4. The clock of claim 1, wherein the optical tweezer array has a wavelength of 497 nanometers.

5. The clock of claim 1, wherein the optical tweezer array is two-dimensional.

6. The clock of claim 1, wherein the vacuum chamber includes a two-stage magneto-optical trap (“MOT”).

7. The clock of claim 6, wherein a first stage of the MOT includes a blue 2D MOT having a wavelength of 461 nanometers.

8. The clock of claim 7, wherein a second stage of the MOT includes a narrow-line MOT having a wavelength of 689 nanometers.

9. The clock of claim 1, wherein the holographic metasurface is positioned outside the vacuum chamber.

10. The clock of claim 1, wherein the cold atoms source comprises a dispenser configured to release the plurality of atoms into the vacuum chamber.

11. The clock of claim 1, further comprising a measurement system configured to collect and measure atom flux of the trapped plurality of atoms.

12. The clock of claim 1, wherein the laser system is chip-scale integrated with frequency combs.

13. The clock of claim 5, wherein the laser system is integrated with a SiN chip.

14. The clock of claim 5, wherein the frequency combs are configured to have spectral overlap with a line of the plurality of atom.

15. The clock of claim 1, wherein the optical tweezer array comprises a plurality of traps for atoms at multiple wavelengths.

16. The clock of claim 1, wherein the atomic array is adapted to manipulate the vibrations and transitions of trapped atoms for a readout of the photonically integrated atomic tweezer clock.

17. A method for constructing a photonically integrated atomic tweezer clock, comprises:
inducing one or more incident laser beams,
generating an optical tweezer array from the one or more incident laser beams via a holographic metasurface,
projecting the optical tweezer array into a vacuum chamber, and
trapping a plurality of atoms using the optical tweezer array in the vacuum chamber,
wherein the plurality of atoms is generated by a cold atoms source.

18. The method of claim 17, wherein the one or more laser beams are generated by a chip-scale laser system.

19. The method of claim 18, wherein the chip-scale laser system is integrated with frequency combs.

20. The method of claim 17, wherein the one or more laser beams are integrated and manipulated on the holographic metasurface to enhance robustness.

21. The method of claim 17 wherein the plurality of atoms are released by at least heating a filling of loaded bulk atom source from a dispenser in the cold atoms source.

22. The method of claim 17, further comprises measuring atom flux of the trapped plurality of atoms by pushing the trapped atoms into a glass cell.

23. The method of claim 17, further comprises manipulating vibrations and transitions of the trapped plurality of atoms within the atomic array.

24. The method of claim 17, further comprising outputting a readout of the atomic tweezer clock.
